(19) United States
(12) Patent Application Publication
(10) Pub. No.: US 2008/0316432 A1
(43) Pub. Date: Dec. 25, 2008

(54) Digital Image Projection System

(75) Inventor: Alex Tejada, New York, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Spotless, LLC, Cambridge, MA (US)

(21) Appl. No.: 11/866,644

(22) Filed: Oct. 3, 2007

Related U.S. Application Data
(60) Provisional application No. 60/937,037, filed on Jun. 25, 2007.

(51) Int. Cl. G03B 21/14

(52) U.S. Cl. 353/28

(57) ABSTRACT

Methods and systems for projecting an image on an object or objects in a performance area are described. Special visual effects may be created using these methods and systems. Information about the object(s) and performance area is acquired and used to process the visual effects. Using this information, images can be tailored to project various colors of light or specific images onto the objects or performers within a performance area by determining the objects' exact shape and adjusting the image accordingly. Continuous information acquisition can be employed to create images that change with the movements of performers and appear to interact in substantially real time with performers, audiences, or objects in the performance area. Multiple information acquisition devices can be used, as well as multiple projection devices, to create complex and interesting special effects.

### CROSS-REFERENCE TO RELATED APPLICATIONS

The subject matter disclosed herein claims priority under 35 U.S.C. §119(e) to provisional U.S. Patent Application Ser. No. 60/937,037, filed Jun. 6, 2007, entitled “DIGITAL FEEDBACK PROJECTOR”, which is hereby incorporated herein by reference in its entirety.

### BACKGROUND OF THE INVENTION

1. Field of the Invention

The present invention generally relates to projectors and lighting. More specifically, the present invention relates to a digital projector that projects images on a moving object.

2. Description of the Related Art

One of the most important elements of a live performance is lighting. Proper and effective use of lighting can create dramatic effects and help ensure the success of a performance. There are many types of lights and lighting tools available which provide options to the stage manager or lighting technician. Different colored lights can be projected on a stage creating particular moods or impressions. Different sizes of spotlights or framed lighting effects are often used to light specific areas of a scene or performance. With the advent of laser technology, the granularity of lighting effects has been increased. Other special effects, such as strobe lighting, are available. However, lighting is typically somewhat limited in its flexibility, especially compared to the effects available through the use of computers in non-live entertainment. The most advanced lighting effects pale in comparison to the computer generated special effects that audiences are accustomed to seeing in film and television productions.

Projections of images, moving and stationary, can provide additional dramatic effect to live performances. The ability to project full images of scenes as background in a production can be an effective way to set a scene. Projected images may be used for other purposes, as well, providing additional tools to the lighting designer. However, these projections also suffer from limitations. Shadows from performers can cause the projection to become distorted and obvious to audiences. Projections must typically be projected onto a flat surface of a specific construction, such as a projection screen, in order to be properly viewed. And performers cannot believably interact with such projections. Thus, the current methods of using projected images or live productions have limited usefulness.

More advanced technologies have been developed which can detect the movements of performers or placement of objects and project specific images or lighting effects based on that information. However, these techniques still suffer many of the drawbacks of traditional lighting and image projection techniques. For instance, even though a spotlight may be able to follow a performer around the stage, it still has the limited functionality of a spotlight. The typical spotlight cannot be made to illuminate objects without having spillover light causing shadows. Images may be projected on a floor or background based on the movements of people or objects in the area, but the image projection technique suffers from shadowing, lack of interactivity with the performers, and projection surface requirements. Such mechanisms also lack the ability to customize the lighting effect to particular shapes of objects in the performance area, and modify that custom lighting effect to fit moving objects or performers. Therefore, it would be desirable to have a light and image projection system that would allow greater content capability than current lighting techniques, with the flexibility and interactivity that is currently impossible with image projection.

### SUMMARY OF THE INVENTION

In one embodiment of the present subject matter, a digital feedback projection system is provided, which comprises image detection components which collect image data about a performance area and/or the objects or persons within the performance area and transmit that information to processing components. The processing components process the detected image and generate image an augmented image for projection. The processing components may also alter the image information to introduce image effects as desired. Such processing components may be programmable, increasing the flexibility of the digital feedback projection system. The processed image information is then sent to at least one high resolution projector, which projects the image as provided by the processing components.

Multiple image detection devices and components may be used, as well as multiple projection components, to create almost limitless special effects. A background screen may be used with rear projectors, creating effects such as performers blending into a scene or becoming invisible. Very specific shape information can be obtained by the image detecting components, allowing the high resolution projector to customize the image such that objects or performers have specific lighting or images projected only onto them, while the remainder of the projected image contains different lighting or images.

Various devices and components may be used to acquire information about a performance area and project images into the performance area. Thermal, infrared, 3-D LIDAR, 3-dimensional or regular color cameras may be used to acquire information. Arrays of cameras and inertial measuring units may be used to further supplement information derived from the performance area. Variously powered projectors of various resolutions may be used in any combination and configuration such that the intended effects are created. Filtering mechanisms may be put in place so that devices projecting images do not interfere with devices acquiring image information, and vice versa. Each of the devices and components within a digital feedback projection system may be configured to communicate with each other over a network, which may be wired or wireless. Multiple digital feedback projection systems may also be connected and employed together to produce effects.

The present system and method are therefore advantageous in that they provide a means to project specific images exactly onto objects or performers in a performance area. Among other effects, this allows the projecting light into an object or performer without the creation of a shadow. In one embodiment, the present system and method perform a function similar to a spotlight, but without casting a shadow or having a “spot”. The present subject matter also allows such projections to dynamically update such that the images can be projected on moving objects in real-time. The present system and method also provide the advantage of detecting and incorporating the scenery and background of a performance area into a projected image, allowing the creation of a multitude of special effects, including performer invisibility and translucence. Using high speed GPUs, real-time effects such as the behavior of liquids and physical properties can be solved live, thus making the illusion that a performer is filled with liquid.

### BRIEF DESCRIPTION OF THE DRAWINGS

FIG. 1 is a graphical representation of an exemplary, non-limiting embodiment of a digital feedback projector.

FIG. 2 is a graphical representation of an exemplary, non-limiting configuration of a digital feedback projector in a first mode of operation.

FIG. 3 is a graphical representation of an exemplary, non-limiting configuration of a digital feedback projector in a second mode of operation.

FIG. 4A is a graphical representation of the resulting effect created by one non-limiting, exemplary embodiment of the present disclosure.

FIG. 4B is a graphical representation of the resulting effect created by another non-limiting, exemplary embodiment of the present disclosure.

FIG. 5 is a graphical representation of an exemplary, non-limiting configuration of a digital feedback projector in a third mode of operation.

### DETAILED DESCRIPTION OF THE INVENTION

### Digital Feedback Projector Overview

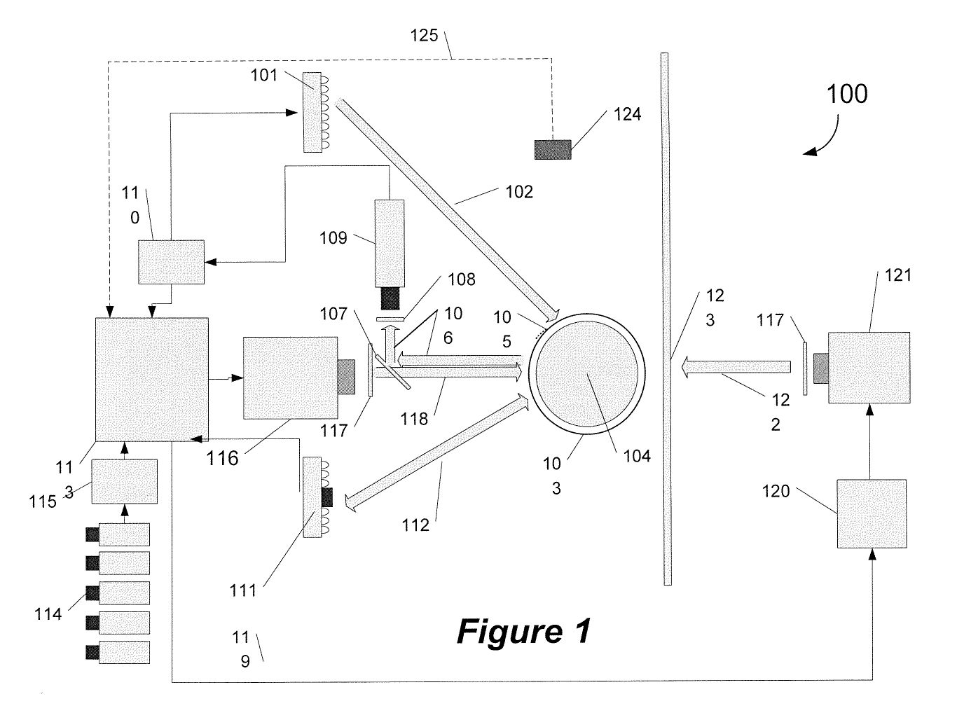

The systems and methods set forth herein may be embodied within a device or multiple devices referred to as digital feedback projector (DFP) systems. A DFP system may be composed of several components which provide the device with the ability to gather information from a performance area, including information about objects or performers within the performance area, and project images onto sections of the performance area or objects within the performance area. One non-limiting, exemplary embodiment of a DFP system is illustrated in FIG. 1. DFP system 100 includes several interdependent and interconnected components. In this embodiment, infrared light generator 101 projects infrared light 102 onto a surface 103 of object 104 within a performance area. Other light or wave generating components may be used, such as a light detection and ranging (LIDAR) device, a 3-dimensional (3-D) camera, an infrared thermal camera or a regular color camera. Any device or combination of devices which can generate waves, light or detectable particles that can be reflected off of objects or surfaces and then detected are contemplated as within the scope of the present subject matter. Moreover, more than one object may be involved in a performance area and the DFP system may operate in a performance area containing any number and variety of objects and backgrounds.

In one non-limiting, exemplary embodiment, surface 103 has a Lambertian reflective character, such that the apparent brightness of the surface to an observer is the same regardless of the observer's angle of view. Typically such surfaces are rough or matte, and not glossy or highly reflective. Object 104 may be any object within the performance area, for example, a person wearing clothing of a Lambertian character, such as a flat white leotard, or a building with matte, neutral colored stone or brick exterior. Other objects, including the background of a performance area or pedestrians on a city street are contemplated as within the scope of the present disclosure. All types of surfaces are also contemplated as within the scope of the present disclosure, including those of non-Lambertian character.

Reflected infrared light 106 is filtered through infrared 45-degree filter-mirror 107, which blocks visible light, and then through polarization filter 108 which rejects specular reflection. Filtered reflected infrared light 106 is then detected by infrared camera 109, which processes and communicates the image represented by infrared light 106 to image processor 110. Because different light, wave, or particle generating devices may be used other than infrared light generator 101, other types of cameras may be required to detect the reflected light, waves, or particles. For example, camera 109 may be a light detection and ranging (LIDAR) device, a 3-dimensional (3-D) camera, an infrared thermal camera, or a regular color camera. Likewise, other filtering and processing techniques and means may be required to allow such alternate embodiments to function as disclosed in the present disclosure. Thus, all such alternative embodiments are contemplated as within the scope of the present disclosure.

Image processor 110 extracts information on the individual objects, performers, or other items within the performance area and calculates the reflection coefficients on the entire surface of each such object. In one embodiment, invisible markings 105 may be placed on the surface of object 104. One example of an invisible marking material is infrared detectable ink. Other invisible markings may be in the form of special materials sewn into or attached to a performer's clothing, special materials used in paints, or make-up containing invisible marking material applied to the performers' bodies. Other means and mechanisms of creating invisible marking detectable only by particular detectors are contemplated as within the scope of the present disclosure, as well as implementation of the present subject without the use of invisible markings. Invisible markings 105 may be used to help the image processing software within image processor 110 to calculate the orientation of the object, the shape of the object, or other characteristics of an object. This information is sent to image synthesis graphics processing unit (GPU) 113 which may use such information for further calculations.

GPU 113 may be a single high speed GPU, or a combination of several GPUs and related components capable of performing the advanced and high speed calculations and processing required to accomplish the desired effects, including generating physics-based material effects in real-time. All such configurations of processing units and components are contemplated as within the scope of the present subject matter. GPU 113 is programmable and may be connected to all the necessary components required to run a computer program. Computer programs can be used to direct the GPU's processing such that the special effects images desired are created, providing great flexibility to the image designer.

In the illustrated embodiment, 3-dimensional (3-D) camera 111 may be used to obtain the true 3-D shape of object 104 from reflected rays 112. Many implementations of 3-D cameras are known to those skilled in the art, and any such camera which is capable of performing the tasks required of the present subject matter are contemplated as within the scope of the present disclosure. A 3-D camera capable of high frame-per-second rates is desirable for image processing where there are moving objects within the image, requiring continuous recalculation of the changing image. Information from 3-D camera 111 is sent to GPU 113. 3-D camera 111 may be used along with a thermal infrared camera, or other heat- or object-detecting cameras such as infrared camera 109, that picks up object heat or object shape information and sends such data to GPU 113. Such shape or heat information may include body heat generated by human or animal performers. GPU 113 can then perform the required processing and calculations to allow DFP system 100 to project certain images only onto a single object, specific objects, or parts of specific objects, or onto backgrounds or specific parts of backgrounds. This allows the system to tailor its projections to produce the desired effects.

In this embodiment, an array of five cameras 114 called environmental cameras (EMAC) is employed, which records in real time the images surrounding object 104. EMAC 114 cameras may be arranged in a cube format in order to register the entire contents of the performance area. The cube image processor 115 uses the five real time images derived from the five cameras in EMAC 114 camera array to give materials reflection or refraction information for the image that is to be projected by DFP 100. Such information is then provided to GPU 113 for processing. Alternatively, the information from EMAC 114 may be fed directly to GPU 113, which may process EMAC information directly. Other numbers and configurations of cameras and processors may be used to create an EMAC camera array and process its data, and all such embodiments are contemplated as within the scope of the present subject matter.

Using the image information obtained from various sources, which may include EMAC 114, 3-D camera 111, infrared camera 109, and any other input sources or devices which measure the environment of and objects within the performance area, GPU 113 generates an image of the performance area including all of its physical parameters and shape information on objects contained therein, and renders a 3-D image. Any alterations of the image, or desired special effects, are also included in the image. Such alterations may include adding physics-based material effects. The 3-D image and related information is then sent to high resolution, high power digital projector 116. The light from projector 116 is then filtered by filter 117 that blocks all infrared light coming from the projector that can interfere with the other infrared sources. Filtered image 118 is then projected into the performance area. Other types of filtering as well as other projection mechanisms and means are contemplated as within the scope of the present disclosure.

The image projected by projector 116 may be an image covering the entire performance area, but containing altered image sections which are projected only on the exact shapes of objects or portions of the performance area to produce intended effects. For example, for an intelligent spotlight effect, the part of the image that is exactly covering the shape of a performer may be projected using bright light projection, while the remainder of the image covering those portions of the performance area not occupied by a performer are projected using dark light projection or shadow projection. Alternatively, a building may be within the performance area, and it may be projected using a wet, dripping paint image exactly within the contours of the building's shape, while the remainder of the performance area is projected in a contrasting colored light. As should be appreciated, many image effects are possible due to this aspect of the present subject matter. Even more complex and impressive effects may be achieved with the use of a DFP system having several projectors, which may be located at various locations in relation to the performance area. Projectors may be placed behind and to the sides of the performers to create an effect of a costume covering the entire body of the performer. Screens may be placed in locations within the performance area such that images can be projected from behind onto the screens, as well as from the front onto performers, such that performers can be made to appear translucent or invisible. Countless other effects are possible with the DFP system.

In the embodiment illustrated in FIG. 1, rear image 119 is generated by GPU 113 and sent to rear GPU 120 to be synchronized with front image 118. Rear GPU 120 processes rear image 119 as needed and sends the image to medium resolution, high power projector 121 which projects the image on rear screen 123. Other means and destinations for rear-projected images are contemplated, as well as not using rear projection at all. The rear projection is also filtered with infrared filter 117 which blocks infrared light in order to avoid projecting infrared light and interfering with other infrared detection cameras and systems. Other filters as well as multiple position projections systems utilizing other projection positions beyond, or instead of, front and rear projection are contemplated as within the scope of the present disclosure.

In one embodiment, inertial measurement unit (IMU) 124 is used to provide a virtual pointer system in the performance area to an object within the area, such as a human or animal performer. IMU signal 125 is transmitted to GPU 113 so that inertial and position information may be used by GPU 113 to create specialized effects. IMU signal 125 may be transmitted wirelessly, to facilitate ease of DFP system 100 set-up, or it may be transmitted using wires. Multiple IMUs may be installed to facilitate the creation of special effects. IMUs may serve as object positioning units, providing real-time data to the DFP system on the movements and changes in shape of objects or performers in the performance area to assist in providing special effects.

There are various possible configurations and combinations of components of a DFP. The particular configuration and component composition will be dependent on the desired effect and application. For example, several cameras, image acquisition devices, and projectors may be required for complex image projection in large areas. When several components are used spread around a large area, wireless transmission of data may be useful to ease installation of such a system. Multiple DFP systems may likewise be communicatively connected to produce a cohesive image effect. Alternatively, multiple DFP systems may be communicatively connected to produce distinct, but related effects. For instance, one or more DFP systems may be employed in a gaming system, such that individual gamers are illuminated with game-specific images, such as character costumes or wounds inflicted during the game. Various types of networks may be used to connect several DFP systems and/or their components, and any such network capable of carrying the required data is contemplated as within the present subject matter. Moreover, components of a DFP system, such as a projector or an image acquisition device, may be mounted on motorized mechanisms such that the component can follow a scene, objects, or performers, and perform the tasks necessary to produce the intended image or effects.

### Methods and Modes of Operation

There are several modes and methods of implementing the present subject matter, three of which are described herein. Such methods and modes may be implemented using the DFP system described herein, or using other systems which facilitate the subject matter. All other methods and modes of implementing the present subject matter are contemplated as within the scope of the disclosure. Special effects may be created by programming the DFP system, including its processing components, to process and project images according to computer programs.

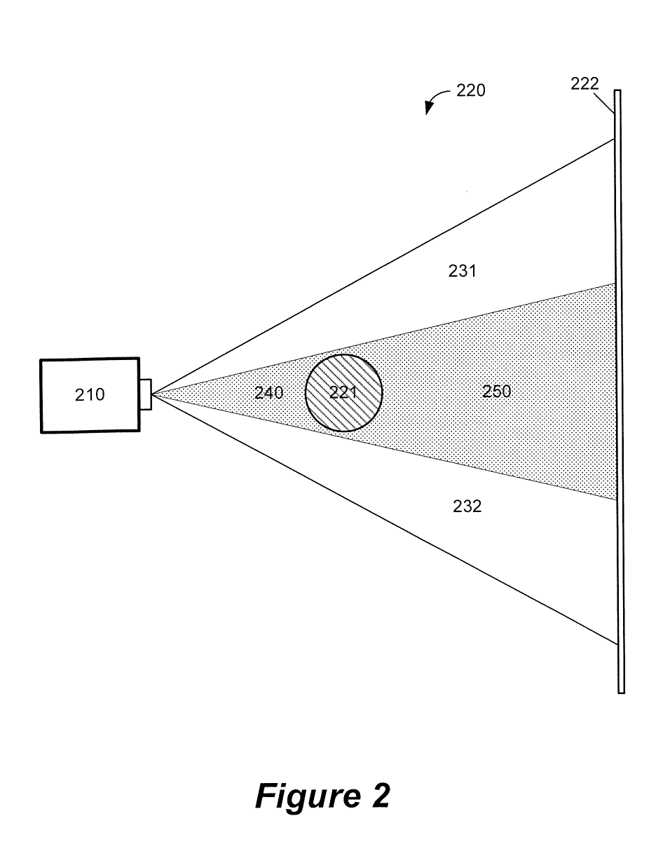

The first mode of operation is generally used when there are one or more objects within the performance area, and the desired effect requires that the object or objects are not illuminated, while the objects' surroundings are illuminated. One effect which may be achieved using this mode of operation is the interaction by performers with a projected environment. For example, when ice skaters are skating across an ice rink, an effect may be produced which makes it appear as though they are leaving ripples in water on the ice rink as they skate. Such effects are only truly effective if the projected images are seen on the background but not on the performers. The present subject matter enables such effects. FIG. 2 illustrates one example of the present subject matter utilized in the first mode of operation. Performance area 220 contains object 221 and background 222. Object 221 may be a performer or multiple performers, or a stationary or mobile object of any type. Background 222 may be a screen installed in the performance area behind objects or performers, or it may be a floor in the performance area on which objects and/or performers sit or move. Other types of objects and backgrounds are contemplated as within the scope of the present disclosure.

DFP system projector 210 is projecting images into performance area 220. Using the various components discussed herein, and others which may facilitate the operation of the present subject matter, projector 210 acquires image information about the performance area and objects therein, and projects an image around object 221, so that the image does not fall on object 221, but only on the background. The image is projected in area 231 and 232, which fall on background 222. Projector 210 projects dark light, or shadow, onto object 221 in area 240. Shadow area 250 is created behind object 221. Rather than merely directing light onto certain objects or in certain portions of the performance area, or physically following objects or movements of objects, projector 210 projects images onto the entire performance area. Projector 210 may project dark images, or shadow, where a bright image is not desired. By adjusting the areas of dark projection and bright projection to match the shape of objects, the DFP system can selectively project images onto various objects and backgrounds to create the desired effect. Desired effects may include physics-based material effects. In the case of a moving object, the DFP system constantly performs the calculations necessary to change the image as needed to maintain the desired effect. Such calculations may be performed in real-time, or near real-time by a GPU or other processor or combination of processors and components. Any such processing and means to accomplish said processing is contemplated as within the scope of the present subject matter.

By using a rear projecting DFP system, such as that illustrated in FIG. 1, shadow area 250 can be further illuminated behind object 221, thus creating a convincing effect of an object interacting with an environment projected by the DFP system. Alternatively, other projectors installed at various angles relative to the object may be used to project adjusted images, thus making it appear as though there is no shadow created by the object. The images projected by the DFP system can be dynamically altered using the component as described herein, making it appear as though the object is affecting the projected image. For instance, a performer can appear to be affecting the physical behavior of smoke, rain, or other airborne particles. Using images projected onto a floor or other horizontal background, a performer can appear to be interacting with projected images of creatures or water. As should be appreciated, the present subject matter offers almost limitless interactivity options.

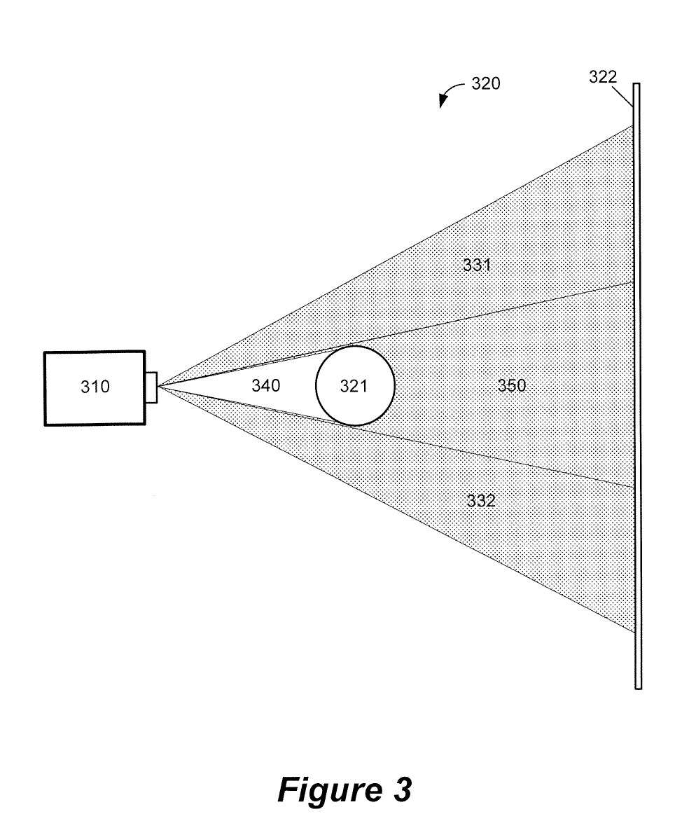

The second mode of operation is essentially the opposite of the first mode. In this mode, illustrated by FIG. 3, the bright projection is concentrated on object 321, and dark projection is used surrounding object 321 in areas 331 and 332, based on information acquired about performance area 320 by the DFP system. Shadow area 350 is created by object 321. The effect of this mode of operation is to project specific image 340 onto an object without affecting the surrounding performance area. Alternatively, a specific image may be projected on object 321 while different images may be projected elsewhere in the performance area. This mode can be used to project images on performers using information about their exact shape which is continuously obtained and processed by the DFP system, making them appear to dynamically change costumes, face make-up, or appearance while in the performance area. Alternative uses include making objects appear to change color, texture, or material while being seen. As applied to people, this effect can be used to alter a person's appearance dynamically in conjunction with a performance or other activity. For example, gamers can be made to appear in certain costumes or wounds can be made to appear on them as they interact with the game and other gamers. Performers can be made to appear to change costume or make-up during a live performance. As applied to inanimate objects, examples of this effect include a building appearing to be covered in wet paint, or appearing to change from a brick exterior to a liquid metal exterior. An intelligent spotlight application is yet another possible use of the present subject matter. The DFP system can automatically adjust the bright light projection to conform to the exact shape of an object or performer, lighting the object or performer without causing any shadow effect because the bright light is shaped exactly to the shape of the object or performer with no spillover of bright light onto the background because the remainder of the performance area is projected with dark light.

In the embodiment illustrated in FIG. 3, as in that illustrated in FIG. 2, the background may be made to appear with a different image, shadows may be compensated for, or other effects may be employed by using multiple projection devices as part of the DFP system. For instance, an additional projection device may be employed in the rear, behind background 322, projecting a different image and setting a background for object 321. Additional projectors may be employed at different angles and positions such that the desired effect may be achieved. One results of such a multi-projector system is the appearance of invisibility of a performer. This is possible by programming the DFP system to project onto the performer images of the background of the performance area such that the performer matches and blends into the background. As should be appreciated, numerous other uses and effects are possible.

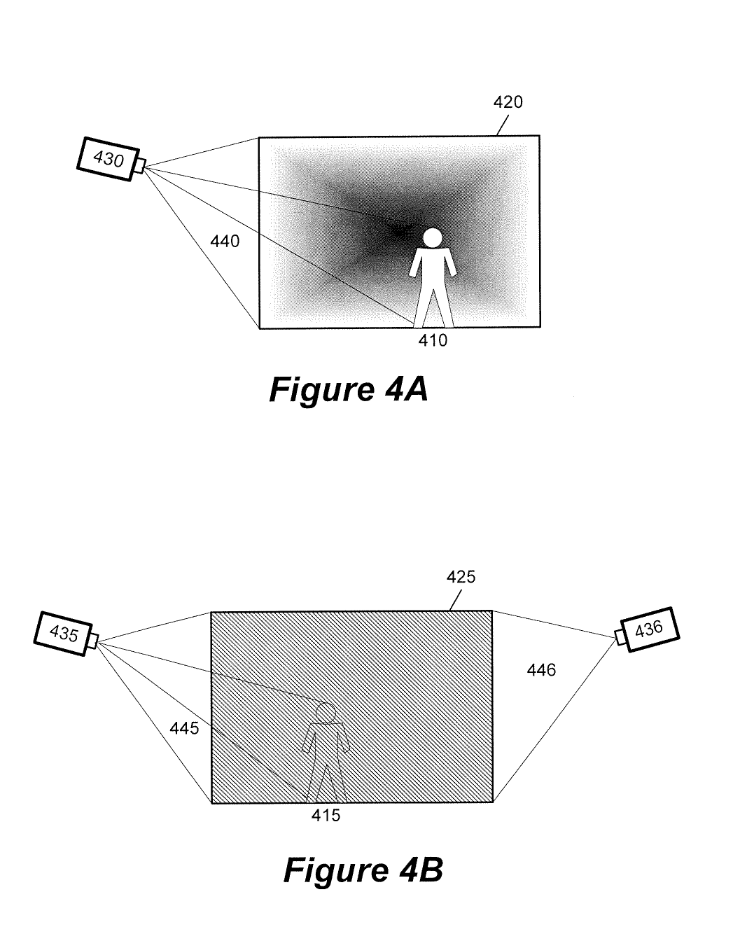

Examples of the result of implementing the present subject matter to achieve the effects described herein with regards to the first and second modes of DFP system operation are illustrated in FIG. 4. FIG. 4A illustrates an application of a DFP system in the first mode of operation described above. Image 440 is projected by DFP system projector 430 onto background 420. Performer 410 is standing in front of background 420, however, because of the capability of the DFP system to detect and incorporate the shapes of objects and performers into projected images, the image 440 is tailored such that performer 410 does not have the background image projected onto him. Thus, background 420 is illuminated with a specific image, while performer 410 is not illuminated, or is illuminated with a different image. This illumination effect may be maintained while performer 410 moves in front of background 420, because, as described above, the DFP system can recalculate the shape of performer 410 continuously and adjust projected image 440 in real-time. A color camera, such as camera 109 in FIG. 1 which may be a color camera, may be used to adapt the projected color surface variations in order to adapt the image and compensate for true color projection.

FIG. 4B illustrates another potential visual effect made possible by implementing one embodiment of the DFP system. In this figure, the system is configured to create an illusion of performer invisibility, translucence, or blending into a background. DFP system projector 435 projects image 445 onto the front of background 425, in front of which performer 415 is positioned. DFP system projector 436 projects image 446 onto background 425. Projector 436 may be configured to project image 446 onto the front of background 425, or onto the rear of background 425. For rear projection, a material such as that used in the construction of projection screens may be employed, so that the rear-projected image may be visible from in front of background 425. The DFP system is programmed such that image 445 projects exactly onto performer 415 the content of the background image in front of which performer 415 is standing, without projecting bright images outside of the shape of performer 415, thus eliminating any shadows. Image 446 is programmatically constructed to be the complete background image. Thus, an effect is created wherein performer 415 matches the background, without casting a shadow, and thus creating an effect of blending into the background. The result of this effect may be near-invisibility or performer translucence. By using additional projectors and DFP system configurations, such effects can be even further enhanced.

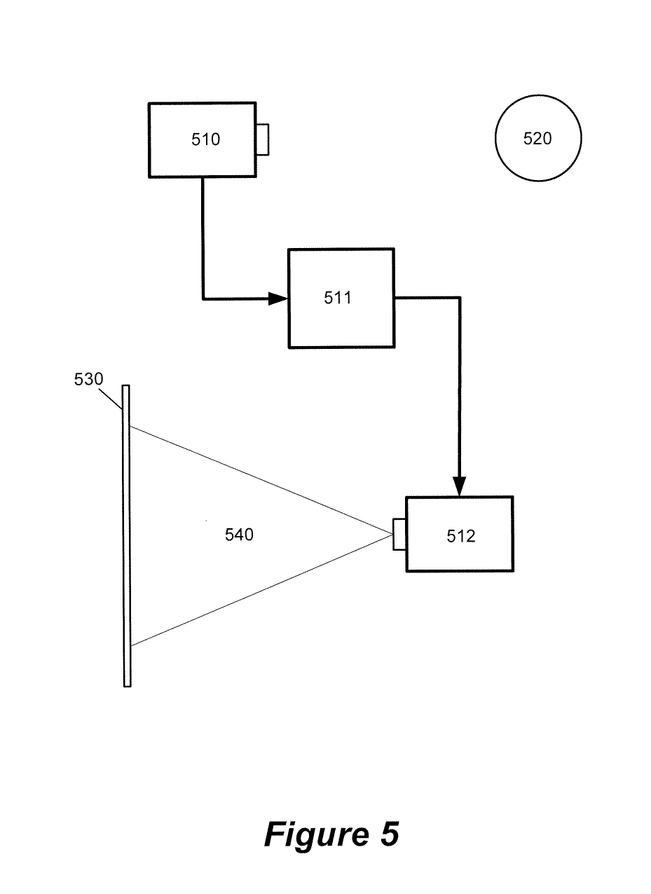

A third possible mode of operation is illustrated in FIG. 5. In this embodiment, the DFP system derives image information from one area and projects the image in another area. For example, image information may be derived from dancers in a room offstage, while the resulting image, complete with desired effects, is projected onto a screen onstage. In FIG. 5, one component of the DFP system, image acquisition device 510, collects information about object 520. Component 510 may also collect information about the performance area in which object 520 is located, and may collect information on several objects within the performance area. Component 510 may be composed of any of the various detection and image acquisition technologies and means as recited herein, or any other means of mechanisms which provide some form of information or data on a live performance or performance area.

That information is relayed to processor 511, which performs the necessary calculations and processing to prepare an image to be provided to projection device 512. Such processing may include manipulation of the image to introduce special effects. For instance, dancers can be rendered as non-human creatures in a forest setting, or actors can be rendered as cartoon characters in an animated world. Processor 511 may include one or more GPUs, and any other processors or components that accomplish the image processing tasks as described herein. Once processed, the image is transmitted to projector 512, which projects the image onto a performance area. This may be a simple projection screen, or it may a less traditional projection area, such as a building or an arena floor. Other projection areas are contemplated as within the scope of the present subject matter, as are various other configurations and combinations of cameras, projectors, image acquisition devices, and processing systems.

As can be appreciated, combinations of the above modes of operation, as well as other modes of operation and combinations thereof, may be useful and effective in producing various desired imaging effects. Any components or configurations recited herein are intended to include equivalents and similar components and configurations that help achieve the objectives of the subject matter described herein. Also included within the present subject matter is any software, or storage medium containing such software, that enables any embodiment or portion of the present subject matter.

What is claimed is:

1. A digital feedback projector system, comprising:
an image detection system configured to capture at least 3-dimensional information about the physical location of at least one object within a performance area;
one or more processors configured to receive and process the captured performance area object information, generate substantially real-time, physics-based material effects that adapt to the shape of the at least one object, and generate image projection information incorporating the effects for the at least one object; and
an image projection system configured to receive the image projection information from the processor and project at least one image onto the at least one object within the performance area based on the image projection information.

2. The system of claim 1, wherein the at least one object is a person.

3. The system of claim 1, wherein the at least one object is inanimate and motive.

4. The system of claim 1, wherein the information captured within the performance area about the physical location of the at least one object includes information about the shape of the object.

5. The system of claim 1, wherein a first image is projected onto the at least one object and a second image is projected onto at least a portion of the performance area.

6. The system of claim 1, wherein the at least one object is marked with invisible markings detectable by only a specific type of detector.

7. The system of claim 1, wherein processing the captured performance area object information and generating image projection information includes altering the image to create a visual effect.

8. A method for projecting images substantially in real-time on at least one object in a performance area, comprising the steps of:
obtaining information on a performance area and at least one object therein, the object also being in a projection area;
processing the information to generate projection image information; and
projecting at least one image onto the at least one object within the projection area.

9. The method of claim 8, wherein processing the information to generate projection image information further comprises:
calculating the exact shape of the at least one object within the performance area from the information obtained on the performance area and the at least one object; and
generating projection information wherein a first image is projected onto the at least one object within the performance area using the at least one object's exact shape calculation, and a second image is projected onto at least one other portion of the performance area.

10. The method of claim 8, wherein information on the performance area is continuously obtained and processed, and wherein the image projected into the projection area is continuously updated.

11. The method of claim 8, wherein processing the information to generate projection image information further comprising altering the projection image information to introduce visual effects.

12. The method of claim 8, wherein projecting at least one image into a projection area further comprises projecting two or more images into the projection area from two or more projectors located in different parts of the area surrounding the projection area.

13. The method of claim 8, wherein projecting at least one image into a projection area further comprises:
projecting a first image onto the front of the projection area; and
projecting a second image onto a background from the rear of the projection area.

14. A system for projecting images onto at least one object within a performance area, comprising:
means for capturing information about the physical shape of at least one object in a performance area;
means for receiving and processing the captured performance area object information;
means for generating image projection information for the at least one object; and
means for receiving the image projection information from the processor and projecting at least one image onto the at least one object within the performance area based on the image projection information.

15. The system of claim 14, wherein the at least one object is a person.

16. The system of claim 14, wherein the at least one object is inanimate and motive.

17. The system of claim 14, wherein the information captured within the performance area about the physical location of the at least one object includes information about the shape of the at least one object.

18. The system of claim 14, further comprising means for projecting a first image onto the at least one object and projecting a second image onto at least a portion of the performance area.

19. The system of claim 14, wherein the at least one object is marked with invisible markings detectable by only a specific type of detector.

20. The system of claim 14, further comprising means for altering the at least one image based on the image projection information to create a visual effect.
